(19) United States
(12) Patent Application Publication
(10) Pub. No.: US 2008/0124971 A1
(43) Pub. Date: May 29, 2008

(54) Service provider patch panel assembly

(76) Inventor: Richard A. Hoelzel, Pawcatuck, CT (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(21) Appl. No.: 11/327,624

(22) Filed: Jan. 6, 2006

(51) Int. Cl. H01R 13/60

(52) U.S. Cl. 439/540.1; 379/413.04

(57) ABSTRACT

A patch panel is configured to be mounted to a rack or in an enclosure, facilitates cable management functions, and enhances space utilization at and around the rack/patch panel assembly. The patch panel advantageously combines the distribution of voice (analog voice & VoIP) and high speed data services (e.g., broadband services) over one single UTP cable. Two pairs of within the UTP cable are dedicated to distribute analog voice and two pairs of the UTP cable are dedicated to distribute Ethernet service to each location (LOC 1 to LOC 13) simultaneously.

### BACKGROUND OF THE DISCLOSURE

1. Technical Field

The present disclosure relates to an advantageous patch panel assembly and, more particularly, to a service provider patch panel assembly that is configured to be mounted in a structured wiring enclosure, facilitates cable management functions, and enhances administration and distribution of voice (analog and VoIP), data, Ethernet/Internet access, IPTV and integrates line seizure security applications.

2. Discussion of Background Art

Patch panels are well known in the field of voice and data communication systems. A patch panel generally provides a plurality of network ports incorporated into a single structural element that connect incoming and outgoing lines of a local area network (LAN) or other low voltage communication systems. Patch panels are usually housed within a telecommunications closet or in an alternative location appropriate for patching cables. Typical patch panels are mounted to a rack or enclosure that generally include other patch panels. The patch panels include a plurality of port locations that function as a sort of static switchboard, using cables to interconnect computers associated with a LAN and/or to connect computers to an outside network, e.g., for connection to the Internet or other wide area network (WAN) or may be used to distribute telephony service. A patch panel generally uses a sort of jumper cable, called a patch cord, to create each interconnection.

In a typical installation, a data patch panel connects a network's computers to each other and to the outside lines that enable the LAN to connect to the Internet or another WAN. A separate patch panel connects all telephones to the service provider's central office. Connections are generally made with patch cords and the patch panel allows circuits to be easily and efficiently arranged and rearranged by plugging and unplugging the patch cords. Patch panel systems are generally intended to facilitate organization and management in implementing telecommunications wiring systems, e.g., for high speed data networks.

Patch panels are routinely mounted between rack elements so as to permit wires or cables, e.g., unshielded twisted pair (UTP) cables, to be wired to insulation displacement contacts or connectors (IDCs) positioned at the rear face of the patch panel, and to further permit patch plugs to be plugged into jacks or ports positioned in the front face of the patch panel. Typical patch panels are substantially planar, extending horizontally from rack element to rack element. Wires/cables are routed to the desired location at the rear of the patch panel, i.e., in the bounded region defined by spaced rack elements. Patch cords are routed to the desired jack/port on the front face of the patch panel, e.g., from a raceway or the like. Thus, for cable management purposes, the patch cords are generally drawn toward one or the other side of the patch panel at the front of the rack system and, from there, routed to the desired component and/or network communication location.

In addition, as is known in the art, many local area networks use unshielded twisted pair (UTP) cables and UTP-based systems as network transmission media. This is due in part to the large installed base of UTP cables/systems, the cost parameters associated with such cables/systems, and the ease and experience associated with installation of such systems. The demands on networks using UTP systems have increased (e.g., 100 Mbit/s and 1000 Mbit/s transmission rates) over recent years. This evolution in the marketplace has led to a desire for service providers to bundled services (e.g., voice, high speed data, internet access and video) to use existing UTP systems to provide such services not only in a large commercial environment, but also to small businesses and even a residential environment. However, administration and distribution of such bundled services has required use of a separate patch panel in the past to receive and distribute each of the various media. Using separate patch panels for each type of media increases the overall size of the patch panel assembly and requires an additional UTP cable distributed to each location, especially in a residential application

For years, resident homes and small businesses typically have had relatively simple cabling needs. For example, rooms were typically wired or cabled to include a single jack for providing access to a single phone line. However, today's residential and small business environment is vastly different. For example, home and small business offices now require access to multiple data, voice, fax and video applications as well as support for IP based communications such as Voice-Over-Internet Protocol and IP Television. Further, homes and small businesses now commonly include co-axial cabling for television access, cabling for security systems, cabling for multiple telephone and data lines, and cabling for video, s-video and audio transmissions. What is needed is an improved patching system particularly applicable to the residential and small building environment.

Therefore, it would be desirable to have a service provider patch panel assembly that is configured to be mounted to a rack or enclosure, facilitate administration and distribution of service provider bundled services, and enhance space utilization at and around the rack/patch panel assembly.

### SUMMARY OF THE DISCLOSURE

The present disclosure is directed to a patch panel that is configured to be mounted to a rack or in an enclosure, facilitates cable management functions, and enhances space utilization at and around the rack/patch panel assembly. The disclosed patch panel advantageously combines the distribution of voice (analog voice & VoIP) and high speed data services over one single UTP cable. Two pairs of within the UTP cable are dedicated to distribute analog voice and two pairs of the UTP cable are dedicated to distribute Ethernet service to each location (LOC 1 to LOC 13) simultaneously. The patch panel of the present disclosure is generally configured for mounting to a rack or enclosure.

According to exemplary embodiments, the disclosed patch panel assembly includes:
a panel having a first surface and an opposite second surface, the first surface exposing a plurality of input ports, at least one of the plurality of ports being configured to receive an input patch cable operably connected to a broadband or Ethernet device and at least one of the plurality of ports being configured to receive an analog voice line, the second surface exposing a plurality of output ports, each of the plurality of output ports corresponding to a corresponding input port from among the plurality of input ports, the output ports being configured to distribute analog voice and high speed data (e.g., broadband services) on a corresponding output cable; and
a printed circuit board operably connected with respect to the second surface of the panel, wherein the printed circuit board is configured to allow a user to access the at least one analog voice line from any of the plurality of output ports and to access high speed data (e.g., broadband services) from a corresponding output port that corresponds to an input port receiving the high speed data.

The disclosed patch panel assembly may be configured such that the printed circuit board operably connects the plurality of input ports with corresponding output ports, thereby providing user access to the at least one analog voice line and high speed data (e.g., broadband services) from a wall plate having a single 6 position, two telephone connector and a single RJ45 connector, respectively. A cable terminated at a corresponding output port generally has access to two analog voice lines and receives data from a corresponding input patch cable connected to a respective input port location. The printed circuit board may be configured to bridge the at least one analog voice line to each output port and pass at least one high speed data from an input port to a corresponding output port. With reference to the second surface of the noted panel, one or more IDC's may be provided that are configured to receive a 4 pair feed from a network interface device (NID) and pass the same to an incoming RJ45 connector on the first surface. The 4 pair feed generally includes at least one incoming analog voice or high speed data transmission (e.g., broadband services).

In further exemplary embodiments of the present disclosure, the patch panel assembly includes a security module. The security module may advantageously include (i) a security in jack for coupling with the signal at the incoming RJ45 connector; (ii) a RJ31X jack operably coupled to a security system for reporting to a remote security service; and (iii) a security out jack operably coupled to the security in jack. The security out jack is generally operably coupled to an auxiliary disconnect outlet (ADO) for patching the at least one analog voice line and high speed data to a DSL modem to each of the plurality of output ports. An expansion port (EXP) having an RJ45 connector exposed at the first surface of the first panel may also be provided, the expansion module operably connected to the at least one voice line for patching to the ADO of an additional panel for expansion of the system. DSL or broadband service is typically provided to each of the plurality of output ports, e.g., using a patch cord to connect a DSL modem with a switch or router and a patch cable feeding a DSL or broadband signal from the data out port to the DSL modem when operably connected to the ADO via a patch cable. If service is disconnected from the ADO, service is thereby disconnected with respect to the printed circuit board.

The disclosed patch panel assembly may further include a plurality of IPTV jacks. Each IPTV jack generally includes an RJ45 connector exposed at the first surface of the panel to pass a signal to a 4-pair IDC exposed at the second surface of the panel, e.g., for connection with a Cat 5e or Cat 6 cable. In exemplary embodiments of the present disclosure, at least one of the plurality of IPTV jacks is an auxiliary (AUX) jack for future use. Moreover, each RJ45 connector may be connectable to a switch via a patch cord for providing a user-desired service therefrom.

In exemplary embodiments of the disclosed patch panel assembly, a cable is connected to an output port that has access to two analog voice lines and high speed data. Each output port typically includes a 110 IDC exposed at the second surface of the panel. The 110 IDC generally combines analog voice and high speed data signals (e.g., broadband services) on a corresponding UTP cable connected thereto for access by a user. Bridging of the analog voice service is distributed to only the 110 IDC's, while a corresponding input port passes dedicated data to a respective 110 IDC.

The printed circuit board is generally a single PCB bridging analog voice to each output port and high speed digital data from an input port to a corresponding output port. Opposing surfaces of the PCB are used to bridge the analog voice signals to each of the plurality of output ports. One of the input ports may function as an expansion (EXP) port for future expansion of the assembly.

In further exemplary embodiments of the present disclosure, a distribution panel for incoming analog voice and high speed digital data is provided. The distribution panel typically includes:
a single printed circuit board configured to receive and distribute analog voice and high speed digital data (e.g., broadband services) between a plurality of input ports and output ports, at least one of the input ports and respective output ports is an expansion (EXP) module for expansion of the panel;
an analog voice distribution module to distribute up to two analog voice lines to each of the plurality of output ports;
a digital data distribution module for patching Ethernet or Internet transmissions to a respective dedicated one of the plurality of output ports;
an IPTV module for patching IPTV to a respective dedicated one of the plurality of output ports;
an RJ31X interface for operable connection with a remote security service; and
an auxiliary disconnect outlet (ADO) for testing the printed circuit board (PCB) of the panel.

The disclosed PCB generally bridges voice service of two analog voice lines on pairs 1 and 4 of a UTP cable connected to each of the plurality of output ports. Digital data service is typically distributed to a dedicated output port corresponding to a respective input port connected to a selected digital data service on pairs 2 and 3 of the UTP cable connected to the dedicated output port. The ADO further functions to test incoming analog voice, data and broadband services

Additional advantageous features and functions associated with the disclosed patch panel and patch panel assembly will be readily apparent from the detailed description which follows, particularly when reviewed together with the drawings appended hereto.

### BRIEF DESCRIPTION OF THE FIGURES

So that those having skill in the art to which the subject matter of the present disclosure appertains will have a better understanding of uses and implementations of the disclosed patch panel and patch panel assembly, reference is made to the accompanying figures wherein:

FIG. 1 is a front perspective view of a first surface of a panel of a patch panel assembly in accordance with an exemplary embodiment;

FIG. 2 is a front elevation view of the panel of FIG. 1;

FIG. 3 is a rear elevation view of an opposite second surface of the panel of the patch panel assembly illustrating a printed circuit board connected thereto in accordance with an exemplary embodiment;

FIG. 4 is a front elevation view of the printed circuit board removed from the patch panel assembly and illustrating traces for bridging analog voice to each of thirteen IDC (LOC) ports and an RJ45 expansion (EXP) port in accordance with an exemplary embodiment;

FIG. 5 is a rear elevation view of the printed circuit board of FIG. 4 illustrating traces from pins 1, 2 and 3, 6 of the RJ45 of each of the LOC ports to corresponding pins of the respective IDC in accordance with an exemplary embodiment;

FIG. 6 is a schematic diagram illustrating a patch panel assembly connected to a modem and router for distributing voice and data to thirteen user locations in accordance with an exemplary embodiment;

FIG. 7 is a partial rear elevation view of patch panel assembly mounted in an enclosure illustrating an incoming four pair UTP cable that is connected thereto for distribution of voice and data in accordance with an exemplary embodiment;

FIG. 8 is a front elevation view of the enclosure of FIG. 7 illustrating the patch panel assembly and modem/switch/router mounted thereto including patch cords therebetween in accordance with an exemplary embodiment; and

FIG. 9 is a perspective view illustrating the arrangement of wires in a standard four pair UTP cable.

### DETAILED DESCRIPTION OF EXEMPLARY EMBODIMENT(S)

The present disclosure provides advantageous patch panel and patch panel assembly that are configured to be mounted to a rack or enclosure, to facilitate cable management functions, and to enhance space utilization at and around the rack/patch panel assembly. The patch panel and patch panel assembly of the present disclosure may be dimensioned to function in cooperation with conventional rack/console structures, e.g., 19″ and 23″ racks. The patch panel assembly is usable with four pair UTP wire (e.g., Cat 5e and 6), as will be readily apparent to persons skilled in the art. In standard four pair UTP cables (such as cable 25) referring to FIG. 9, pair 1 includes wires 1 and 2, pair 2 includes wires 3 and 4, pair 3 includes wires 5 and 6 and pair 4 includes wires 7 and 8. Each wire in the pairs is of a different polarity, representing the different direction of signal transmission, and is referred to as “ring” (negative voltage) and “tip” (positive voltage). Thus, in a standard UTP cable, wires 1, 3, 5 and 7 are ring while wires 2, 4, 6 and 8 are tip. Furthermore, wires 1 and 2 of pair 1 are blue and correspond to terminals or pins 4 and 5 of a RJ45 under the T568A wiring standard. Wires 3 and 4 are orange and correspond to pins 3 and 6 of a RJ45. Wires 5 and 6 are green and correspond to pins 1 and 2 of a RJ45. Wires 7 and 8 are brown and correspond to pins 7 and 8 of a RJ45.

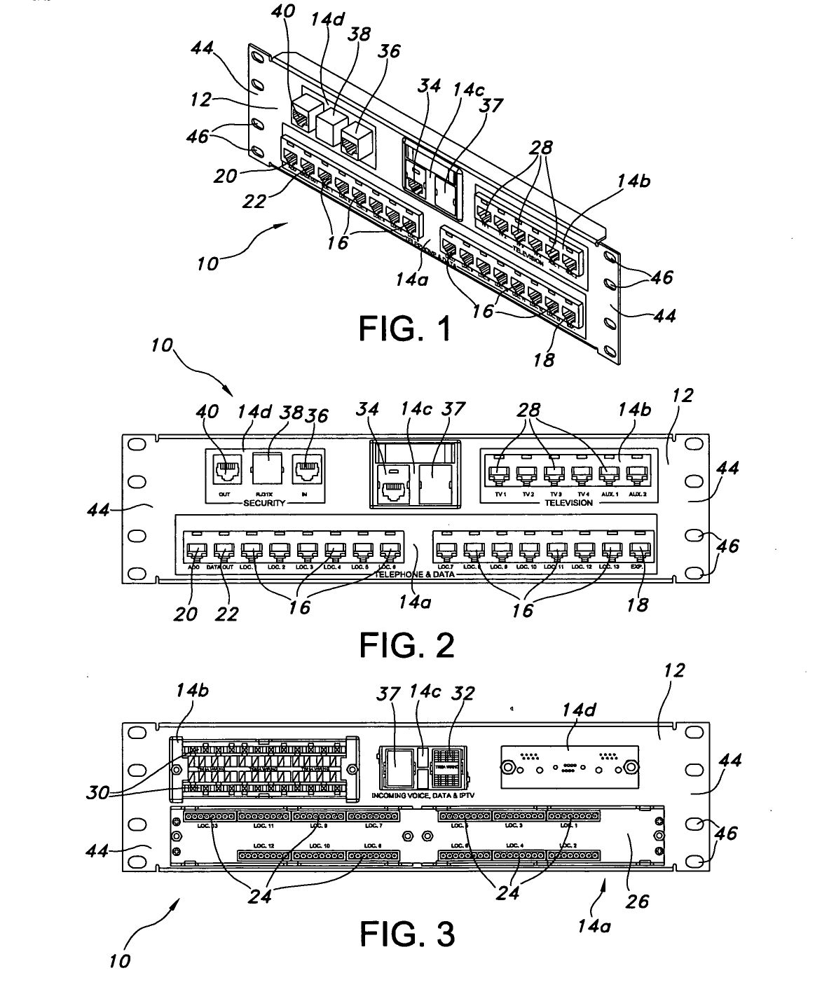

With reference to FIGS. 1-3, an exemplary panel assembly 10 is illustrated according to the present disclosure. According to an exemplary embodiment of the present disclosure, the patch panel assembly includes a panel 12 formed, at least in part, by a single structural element, e.g., an elongated member that is fabricated from a sufficiently rigid material, e.g., steel. In the illustrated embodiment of FIGS. 1-3, patch panel 12 is defined by an elongated steel member that includes a plurality of cut-outs to facilitate receipt/mounting of four port modules 14a-d. Thus, with reference to FIGS. 1-3, the patch panel assembly 10 includes four (4) modules 14a, 14b, 14c, 14d. The first module 14a includes sixteen (16) linearly aligned ports accessible from the front of the patch panel assembly 10 (FIGS. 1 and 2). The first module 14a includes sixteen (16) ports corresponding to the thirteen (13) location (LOC. 1-13) input ports 16, a single expansion (EXP) port 18, an auxiliary disconnect outlet (ADO) 20 and a DATA OUT port 22 on the front surface of panel 10 while the rear surface of panel 10 (FIG. 3) exposes thirteen output ports 24 corresponding to the thirteen input ports 16. The sixteen ports are configured as sixteen RJ45 jacks in an exemplary embodiment as depicted. The first module 14a also includes a printed circuit board (PCB) 26 disposed between the sixteen input ports and the thirteen output ports 24.

The second module 14b includes six (6) linearly aligned input ports 28 accessible from the front of the patch panel assembly 10. Similarly, the patch panel 10 includes six ports 30 corresponding to the six output ports 30 on the rear of panel 10. Four of the ports correspond to connection for IPTV while the remaining two can be used for future expansion of the system that may include an additional two ports for IPTV. The third module 14c includes a single port 32 on the rear panel 12 to receive incoming analog voice, high speed digital data and IPTV. The front panel 10 exposing the third module 14c includes a corresponding port 34 to patch the incoming voice and data to a data IN port 36 of the fourth module 14d. The third module 14c includes a blank 37 for future use where a RJ45 jack may be inserted. The fourth module 14d is a security module that includes three linearly aligned ports exposed at the front of panel 10. One of the three ports is a RJ31X port 38 while the remaining two ports are RJ45 ports on the front panel 10 corresponding to the security data IN port 36 and security OUT port 40. Similarly, the single port of module 14c, the six ports of module 14b and sixteen ports of module 14a are all RJ45 ports exposed at the front of panel 10 in an exemplary embodiment. In total, exemplary patch panel 12 includes twenty-six (26) ports/jacks exposed on a front surface, while an opposite rear surface of the patch panel 12 exposes twenty (20) ports/jacks. The jacks associated with the jack modules of the present disclosure may be of conventional design with appropriate levels of performance, e.g., CAT 5E and/or CAT 6 performance levels. In an exemplary embodiment, the front surface of the panel 12 exposes twenty-five RJ45 jacks and a single RJ31X jack, while the rear surface of the patch panel 12 exposes twenty IDC's.

Exemplary embodiments of the present disclosure include an applique that is adhered to the patch panel 12. The appliqué generally includes pre-printed indicia, e.g., port designations (see, e.g., FIGS. 1-3). The use of appliqué(s) on the surface faces of the patch panel 12 facilitates manufacture and use of the disclosed patch panel. Inclusion of appropriate indicia on such appliqué(s) facilitates the interconnections that users desire to effect, while avoiding the potentially expensive and difficult process of printing or otherwise defining appropriate indicia directly on the patch panels. The appliqué(s) are typically fabricated with appropriate rectangular openings (to match up with the openings formed in the patch panels) and advantageously extend substantially from side-to-side. Regions for mounting/adhering additional label-like information may also be provided according to the present disclosure, e.g., below the linearly aligned ports (see, e.g., LOC's 1-13 in FIGS. 1-3).

With further reference to FIGS. 1-3, patch panel 12 includes mounting flanges 44 that are disposed on outboard ends thereof defining a mounting face that includes mounting features 46 for facilitating mounting of the patch panels relative to a rack or console. Such mounting features 46 typically take the form of slots and/or apertures, although alternative mounting features may be employed. Each flange element may also advantageously include or define an extension arm (not shown) that is intermediate the mounting face and the patch panel element to which the flange element is mounted or from which the flange element extends. The extension arm may be dimensioned to facilitate at least partial recessing of the patch panel relative to the rack/console when the patch panel assembly is mounted thereto, as will be appreciated by those skilled in the pertinent art.

As also shown in FIGS. 1-3, the mounting face of flange member 44 includes four (4) apertures to facilitate mounting of the patch panel 12 relative to a rack/console. The number of apertures and arrangement thereof of the mounting face of the flange members is not critical to the present disclosure, although it is generally desirable that the mounting feature cooperate with the features generally found on conventional racks, consoles and the like. Thus, the spacing of the mounting features 46, e.g., apertures, is generally selected to correspond to applicable industry standards, if any.

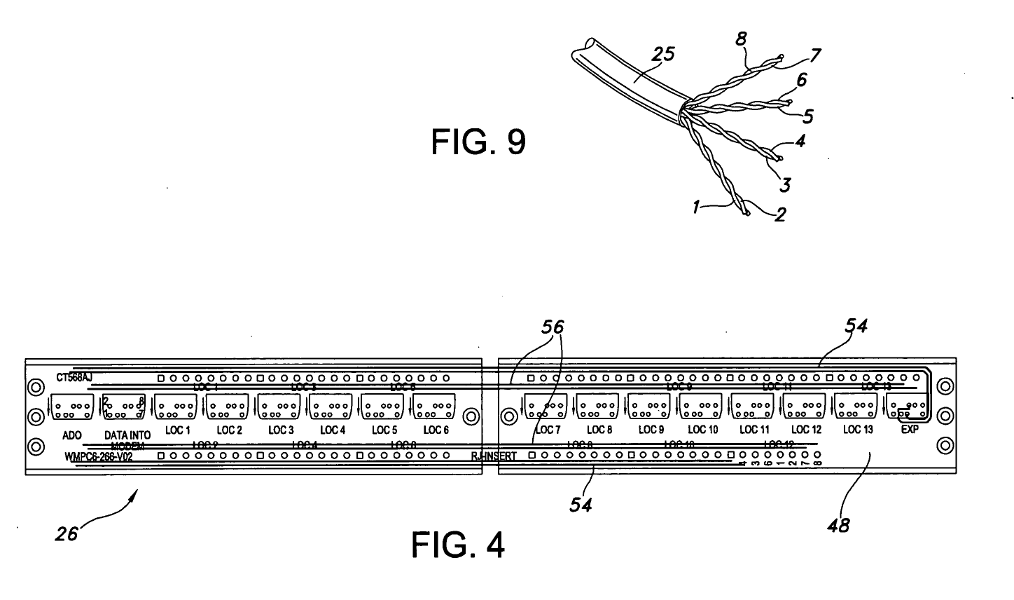

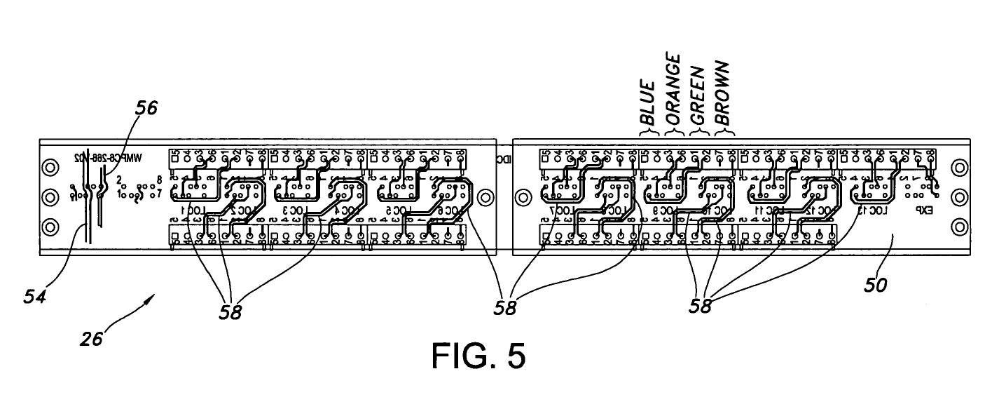

Referring now to FIGS. 4 and 5, opposite surfaces 48, 50 of a printed circuit board (PCB) 26 are depicted, respectively. In an exemplary embodiment, PCB 26 is disposed with the first module 14a. FIG. 4 illustrates the tracings from pins 4, 5 of the EXP port extending to each of the LOC. 1-13 ports via tracing 54 in FIG. 5, while tracing 56 extends to each of pins 7, 8 of each of the LOC. 1-13 ports and the EXP port. In this manner, pins 4, 5 and 7, 8 of the PCB 26 bridge two analog voice lines to the output ports 24 corresponding to the IDCs exposed at the rear surface of panel 12 proving each of the LOC's 1-13 and EXP access to the two analog voice lines. FIGS. 4 and 5 also show that the remaining pins 1, 2 and 3, 6, corresponding to wire pairs 2 and 3, allow dedicated transfer of high speed digital data to a corresponding LOC. 1-13 at pin locations 1, 2 and 3, 6, respectively. FIG. 4 illustrates the pin out configuration from the sixteen RJ45 jacks at the front of panel 12, while FIG. 5 illustrates the tracings 58 from these RJ45 pin outs to the IDC pin out configuration.

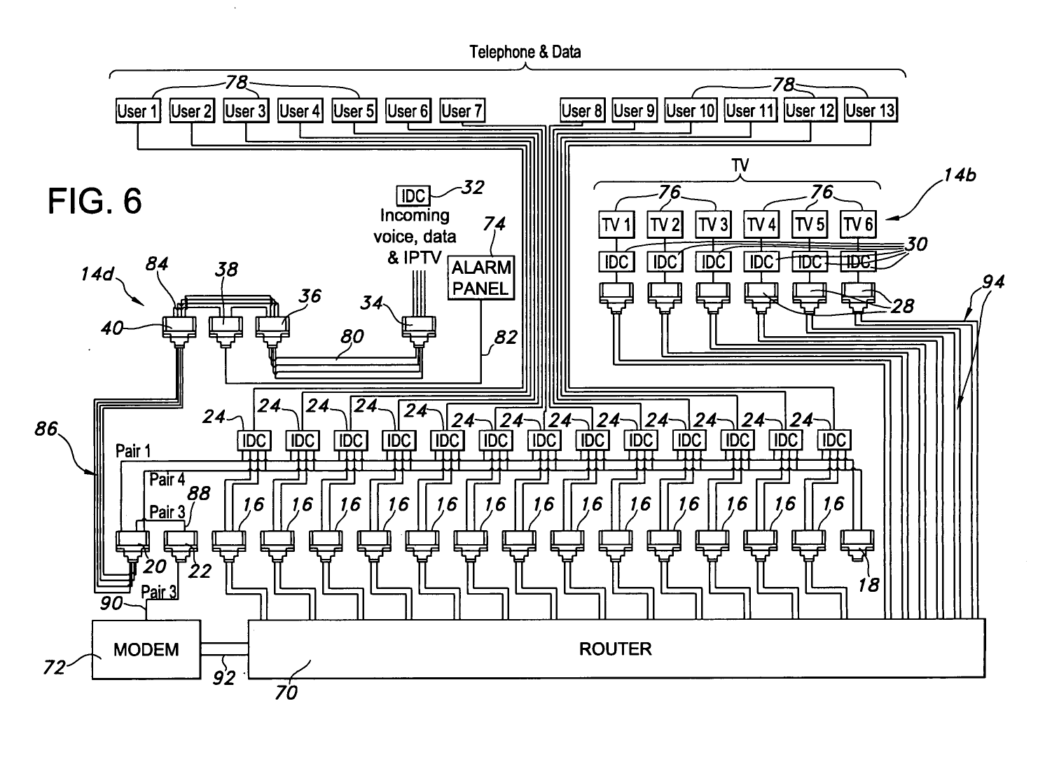

Turning to FIG. 6, a schematic of the patch panel assembly 10 operably connected to a router 70, modem 72, an alarm panel 74, six televisions 76 and thirteen (13) users 78 is illustrated for connection of bundled services from a service provider and distribution in a residential building. In an exemplary embodiment, a user 78 is a computer and/or a telephone. The single port 32 on the rear surface of panel 12 receives incoming analog voice, high speed digital data and IPTV via a four pair feed from a riser closet (not shown), for example, bringing in bundled services including, but not limited to, an analog voice line and a digital subscriber line (DSL) signal. The incoming voice, data and IPTV is carried to the port 34 exposed at the front of panel 12. A first RJ45 patch cord 80 patches the incoming bundled services to the security IN port 36. Thus all four pairs of the four pair feed are plugged into the security IN port 36. Pair 1 (blue pair) is bridged to “in” of the RJ31X port 38 for plain old telephone service (POTS) only when a RJ45 plug is inserted into the RJ31X port 38. When a cord 82 from the alarm panel 74 is plugged into the RJ31X port 38, a dial tone is routed through the alarm panel and back out to the RJ31X port 38. The out pair of the RJ31X port 38 is bridged to pair 1 of security OUT port 40 indicated generally at 84. Pairs 1, 2, 3, and 4 are distributed to the security OUT port 40.

A second patch cord 86 operably connects the security OUT port 40 with the ADO port 20 to feed analog voice and DSL to the output port ports 24 and to the EXP. port 18. Pairs 1 and 4 of cord 86 are operably connected to pins 4, 5 and 7, 8, respectively. PCB 26 as discussed above bridges pair 1 and 4 of cord 86 to respective pins 4,5 and 7, 8, respectively, of LOC. ports 24 and EXP port 18 as discussed above. In this manner, LOC. Ports 24 and EXP. Port 18 each have access to two analog voice lines via bridging of pairs 1 and 4. Further, when the second patch cord 86 is plugged into security out port 40 and ADO port 20, DSL is supplied to the Data IN/OUT port 22 via a pair 3 trace 88 therebetween.

A RJ11 cord 90 feeds a DSL signal to modem 72 via pair 3 on pins 1, 2 of port 22. DSL service is provided to individual room outlets via a respective output port 24 when a patch cord 92 is connected from modem 72 to the router 70 as required. Pairs 2 and 3 are passed to a respective IDC output port 24 at each location (LOC. 1-13) in a non-bridged fashion, while pairs 1 and 4 provide POTS and DSL services bridged between jacks as they are terminated on LOC. 1 through LOC. 13.

As discussed above, the straight four pair IDC port 32 receives IPTV and passes it to the RJ45 port 34 on the front of panel 12. The first patch cord 80 provides the signal to the security module 14d and passes the signal to the first module 14a via the second patch cord 86. IPTV service is available at ports 30 when a patch cord 94 is connected from a switch or router 70 to a respective RJ45 port 28. In an exemplary embodiment, two of the six ports 28, 30 are auxiliary (AUX) jacks usable for future expansion.

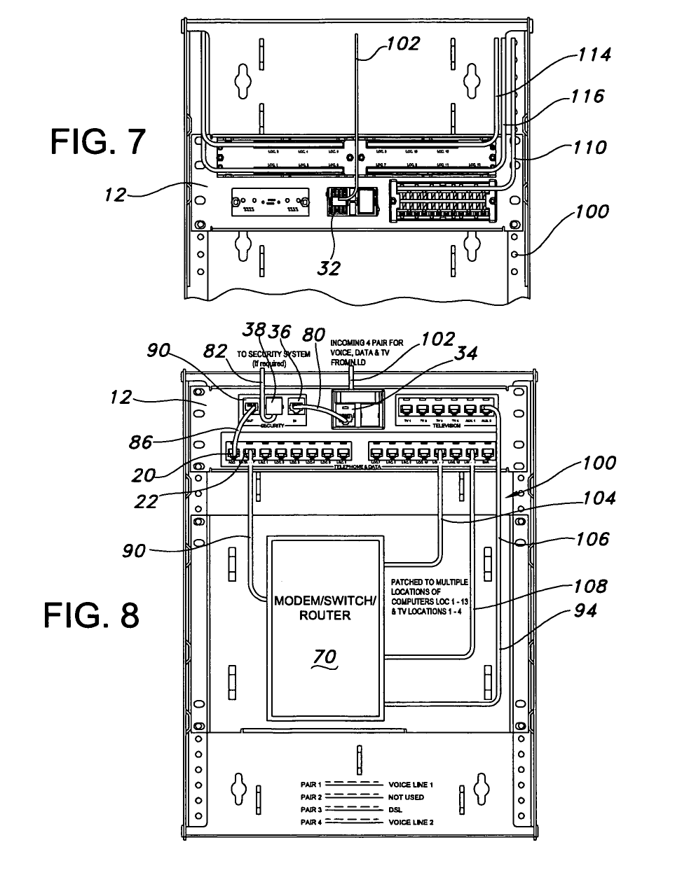

Referring now to FIGS. 7 and 8, patch panel assembly 10 is illustrated as being mounted to an enclosure 100 and depicts the patch cords plugged into the ports for distributing the incoming bundled services from line 102. As described above, incoming line 102 passes analog voice, data and IPTV from a bundled service provider panel or N.I.D. to IDC 32 on the back of panel 12 (FIG. 7), which in turn passes the incoming four pair to a RJ45 jack 34 exposed on the front of panel 12 (FIG. 8). The first patch cord 80 is plugged between jack 34 and security IN jack 36, while the second patch cord 86 is plugged between security OUT jack 40 and ADO jack 20. The RJ11 cord 90 is shown connecting modem/switch/router 70 to the data into or data OUT jack 22. Patch cords 104 and 106 are shown connecting the modem/switch/router 70 to LOC. 11 and LOC. 13 ports 16, respectively. Patch cord 108 connects modem/switch/router 70 to AUX. 2 of module 14b providing IPTV to a corresponding wall plate, for example. Alternatively, connection therebetween provides future expansion of the panel assembly 10. It will be recognized by those skilled in the pertinent art that any number of patch cords may be connected from the modem/switch/router 70 to a desired data (e.g., LOC. 1-13) or TV (e.g., TV1-TV4, AUX. 1 and AUX. 2) location. FIG. 7 illustrates a patch cord 110 exiting an IDC 30 of the respective AUX. 2 RJ45 jack 28. Likewise, patch cords 114, 116 are illustrated exiting from IDC's corresponding to RJ45 jacks 16 of LOC. 11 and LOC. 13, respectively. Patch cord 82 is partially illustrated exiting the RJ31X jack 38 extending to an alarm panel, if required in FIG. 8.

In exemplary embodiments of the present disclosure, patch panel assembly 10 is typically about 3.5 inches in height, i.e., about two rack mounting units (RMUs), using the same EIA/TIA standard rack mount pattern as with commercial products. As also shown in FIGS. 7 and 8, the mounting face of flange member 44 includes a number of apertures to facilitate mounting of patch panel 12 relative to a rack/console or like structure. As with patch panel 10, although the number of apertures and arrangement thereof of the mounting face of the flange members is not critical to the present disclosure, it is desirable that the mounting feature cooperate with the features found on conventional racks, consoles and/or the like. The patch panel assembly 10 provides for pre-terminated designs ideal for installations where space is limited and allows for internal cable management so as to eliminate costly field polishing and termination and facilitates clean, organized, and efficient installations.

The above-described patch panel assembly facilitates the administration and distribution of voice, high speed data, Internet access, video (Internet Protocol TV) and security monitoring, as service providers increasingly combine bundled services to their customers. Rather than using separate panels for the distribution of the various media, the patch panel assembly according to the present disclosure combines them all onto a single unit.

The patch panel assembly according to the present disclosure combines voice distribution for up to two analog telephone lines (POTS), data distribution for Ethernet/Internet, and IPTV. The patch panel assembly includes a RJ31X interface for a security reporting device, an auxiliary disconnect outlet for testing the printed circuit board and connections thereto, and an expansion port for expanding the system. Each output of a corresponding 110 IDC on the rear of the panel (LOC. 1-LOC. 13 combines voice and data onto each respective UTP cable connected to the panel. Bridged voice service is distributed on pairs 1 and 4 (e.g., blue and brown, respectively), and is distributed to only the IDC's on the rear of the panel and not to the respective RJ45 jacks on the front of the panel. The same respective IDC's also support modular patching from data sources to dedicated locations (LOC. 1-LOC. 13) on pairs 2 and 3 (orange and green, respectively). The corresponding RJ45 jack on the front of the panel passes the data to a respective IDC on the rear of the panel.

The above-described patch panel assembly advantageously combines voice and data onto one printed circuit board and bridges voice passing the same to IDC's and an expansion port, while allowing the RJ45 jacks to pass data to a respective dedicated IDC. The cables terminate on the rear panel and the front of the panel provides for modular patching. The patch panel assembly also advantageously includes an integrated DSL/Data output jack and an IPTV patching field. The above-described patch panel assembly advantageously consolidates voice, data, video and security access onto one single modular panel configured in a EIA/TIA standard rack mount pattern.

Although the patch panels and patch panel assemblies of the present disclosure have been described with reference to exemplary embodiments thereof, the present disclosure is not limited to such exemplary embodiments. Rather, the present disclosure extends to and encompasses such modifications and/or enhancements that will be apparent to persons skilled in the art in view of the detailed description provided herein.

1. A patch panel assembly comprising:
a panel having a first surface and an opposite second surface, the first surface exposing a plurality of input ports, at least one of said plurality of ports being configured to receive an input patch cable operably connected to a broadband or Ethernet device and at least one of said plurality of ports being configured to receive an analog voice line, the second surface exposing a plurality of output ports, each of said plurality of output ports corresponding to a corresponding input port from among said plurality of input ports, the output ports being configured to distribute analog voice and high speed data on a corresponding output cable; and
a printed circuit board operably connected with respect to the second surface of the panel, wherein the printed circuit board is configured to allow a user to access the at least one analog voice line from any of the plurality of output ports and to access high speed data from a corresponding output port that corresponds to an input port receiving the high speed data.

2. The patch panel assembly according to claim 1, wherein the printed circuit board operably connects the plurality of input ports with corresponding output ports, thereby providing user access to the at least one analog voice line and high speed data from a wall plate having a single 6 position, two telephone connector and a single RJ45 connector, respectively.

3. The patch panel assembly according to claim 2, wherein any cable terminated at a corresponding output port has access to two analog voice lines and receives data from a corresponding input patch cable connected to a respective input port location.

4. The patch panel assembly according to claim 1, wherein the printed circuit board is configured to bridge the at least one analog voice line to each output port and pass at least one high speed data from an input port to a corresponding output port.

5. The patch panel assembly according to claim 1, wherein a second surface includes an IDC configured to receive a 4 pair feed from a network interface device (NID) and pass the same to an incoming RJ45 connector on the first surface, the 4 pair feed including at least one incoming analog voice or high speed data transmission.

6. The patch panel assembly according to claim 5, wherein the panel includes a security module comprising:
a security in jack for coupling with the signal at the incoming RJ45 connector;
a RJ31X jack operably coupled to a security system for reporting to a remote security service; and
a security out jack operably coupled to the security in jack, the security out jack being operably coupled to an auxiliary disconnect outlet (ADO) for patching the at least one analog voice line and high speed data to a DSL modem to each of the plurality of output ports.

7. The patch panel assembly according to claim 6, further including an expansion port (EXP) having an RJ45 connector exposed at the first surface of the first panel, the expansion module operably connected to the at least one voice line for patching to the ADO of an additional panel for expansion of the system.

8. The patch panel assembly according to claim 6, wherein DSL or broadband service is provided to each of the plurality of output ports when a patch cord connects a DSL modem with a switch or router and a patch cable feeds a DSL or broadband signal from the data out port to the DSL modem when operably connected to the ADO via a patch cable.

9. The patch panel assembly according to claim 6, wherein service is disconnected from the ADO to thereby disconnect service to the printed circuit board.

10. The patch panel assembly according to claim 1, further comprising a plurality of IPTV jacks, each IPTV jack including an RJ45 connector exposed at the first surface of the panel to pass a signal to a 4-pair IDC exposed at the second surface of the panel, each for connection with a Cat 5e or Cat 6 cable.

11. The patch panel assembly according to claim 10, wherein at least one of the plurality of IPTV jacks is an auxiliary (AUX) jack for future use.

12. The patch panel assembly according to claim 10, wherein each RJ45 connector is connectable to a switch via a patch cord for providing a user-desired service therefrom.

13. The patch panel assembly according to claim 1, wherein a cable connected to any of the plurality of output ports has access to two analog voice lines and high speed data.

14. The patch panel assembly according to claim 13, wherein each output port includes a 110 IDC exposed at the second surface of the panel, each 110 IDC combining analog voice and high speed data signals on a corresponding UTP cable connected thereto for access by a user.

15. The patch panel assembly according to claim 14, wherein bridging of the analog voice service is distributed to only the 110 IDC's, while a corresponding input port passes dedicated data to a respective 110 IDC.

16. The patch panel assembly according to claim 1, wherein the printed circuit board is a single PCB bridging analog voice to each output port and high speed digital data from an input port to a corresponding output port.

17. The patch panel assembly according to claim 16, wherein opposing surfaces of the PCB are used to bridge the analog voice signals to each of the plurality of output ports.

18. The patch panel assembly according to claim 1, wherein one of the plurality of input ports is an expansion (EXP) port for future expansion of the assembly.

19. The patch panel assembly according to claim 1, wherein the high speed data includes one or more broadband services.

20. A distribution panel for incoming analog voice and high speed digital data, the panel comprising:
a single printed circuit board configured to receive and distribute analog voice and high speed digital data between a plurality of input ports and output ports, at least one of the input ports and respective output ports is an expansion (EXP) module for expansion of the panel;
an analog voice distribution module to distribute up to two analog voice lines to each of the plurality of output ports;
a digital data distribution module for patching Ethernet or Internet transmissions to a respective dedicated one of the plurality of output ports;
an IPTV module for patching IPTV to a respective dedicated one of the plurality of output ports;
an RJ31X interface for operable connection with a remote security service; and
an auxiliary disconnect outlet (ADO) for testing the printed circuit board (PCB) of the panel.

21. The panel according to claim 20, wherein the PCB bridges voice service of two analog voice lines on pairs 1 and 4 of a UTP cable connected to each of the plurality of output ports, and digital data service is distributed to a dedicated output port corresponding to a respective input port connected to a selected digital data service on pairs 2 and 3 of the UTP cable connected to the dedicated output port.

22. The panel according to claim 20, wherein the digital data includes one or more broadband services.

23. The panel according to claim 20, wherein the ADO further functions to test incoming analog voice, data and broadband services.
